(19) United States
(12) Patent Application Publication
(10) Pub. No.: US 2009/0304076 A1
(43) Pub. Date: Dec. 10, 2009

(54) MEMORY ARRANGEMENT METHOD AND SYSTEM FOR AC/DC PREDICTION IN VIDEO COMPRESSION APPLICATIONS BASED ON PARALLEL PROCESSING

(75) Inventors: Po-Chun Chung, Pingtung County (TW); Guo-Zua Wu, Taichung City (TW); Wei-Zheng Lu, Chiayi City (TW); Nai-Shen Wu, Taichung City (TW); Chi-Yi Kao, Taipei County (TW); Hsin-Han Shen, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 12/347,496

(22) Filed: Dec. 31, 2008

(30) Foreign Application Priority Data
Jun. 4, 2008 (TW) TW097120739

(51) Int. Cl. H04N 7/32

(52) U.S. Cl. 375/240.12; 375/E07.243

(57) ABSTRACT

A memory arrangement method and system for AC/DC prediction in video compression applications based on parallel processing is disclosed. The method and system achieves optimum operating efficiency for data operation and reading based on parallel computing characteristics (Single Instruction Multiple Data (SIMD)) of an operation unit of the system. Additionally, the method transplants a VC-1 video compression system running in an operating system (the Windows operating system, for example) to a system platform using a digital signal processor (DSP) as an operation unit and implements a real-time VC-1 encoder according to parallel computing characteristics of a hardware core of the system platform.

### CROSS REFERENCE TO RELATED APPLICATIONS

This Application claims priority of Taiwan Patent Application No. 097120739, filed on Jun. 4, 2008, the entirety of which is incorporated by reference herein.

### BACKGROUND OF THE INVENTION

1. Field of the Invention

The invention relates to video compression processing, and more particularly to a memory arrangement method and system for AC/DC prediction in video compression applications based on parallel processing.

2. Description of the Related Art

Generally, power consumption of a core operation unit of an intelligent appliance or a multimedia entertainment system is much less than a central processing unit (CPU) of a personal computer. Meanwhile, it is necessary to develop an operation unit providing large operation capacity.

Currently, parallel computing and multi-core architecture are commonly used for CPU designs that enhance clock speed and performance. Similarly, parallel data processing can also improve performance efficiency. With respect to conventional parallel computing systems, pre-processing and arrangement of data critically affect efficiency of subsequent parallel computing operations.

Serial or parallel computing predicts alternating current or direct current (AC/DC) reference coefficients of a frame to reduce data amount, the difference of which focuses on methodology, effects, and data processing.

With respect to the methodological differences, serial computing processes data using only a single operation module, while parallel computing processes the data using multiple operation modules at the same time, wherein data to be processed must be pre-arranged. For AC/DC processing, operation flows of neighboring macroblocks (MB) are the same. Thus, multiple macroblocks can be parallel-processed at the same time.

With respect to the operation, serial computing operates using a single module, wherein prediction operation for only a macroblock is being performed every time, until the whole frame is completely processed. For parallel computing, if N operation modules perform predictions, N macroblocks are predicted for each operation. Thus, operating efficiency of parallel computing is at least N times that of serial computing.

With respect to the data processing, when each block is predicted, reference coefficients of top, top-left, and left blocks of a block to be predicted must be retrieved for prediction. Thus, the reference coefficients are pre-stored using a buffer, and following, the next operation is performed. Thus, for serial computing, the buffer must be updated to reference coefficients of the next macroblock whenever a macroblock is completely predicted, before the next prediction can be performed.

As for parallel computing, since reference coefficients of multiple macroblocks are pre-arranged before calculation is performed, the reference coefficients are re-loaded in the buffer so that data reuse for the reference coefficients of each macroblock can be frequently achieved. The top, top-left, and left reference coefficients of each macroblock are easily retrieved and the reference coefficients stored in the buffer are updated only if processing of a macroblock group is complete, resulting in divergent operation speeds. Data processing for serial and parallel computing is shown in FIGS. 1 and 2.

Referring to FIG. 1, if serial computing is being performed, top reference coefficients of macroblocks must be written in the operation unit for each row chunks and the reference coefficients are written out only when the last row chunk of the last chunk groups (defined in FIG. 5) is processed. If parallel processing is being performed, the top reference coefficients of macroblocks are both written in and out when each row chunk is processed. Referring to FIG. 2, if serial computing is being performed, the top-left and left reference coefficients of macroblocks must be written in each time before AC/DC prediction is being performed. If parallel computing is being performed, parallel reference coefficients can be reused, so only the top-left and left reference coefficients of the first macroblock are written.

As described, video compression allows redundant data to be removed from a frame according to relative positions between pixels of the frame to reduce data amount. Processing for MPEG-4 and VC-1 video standards is performed by predicting AC/DC reference coefficients. For AC/DC algorithms, dependence is included between the block and the “top”, “top-left”, and “left” blocks. Based on data processing convenience, a conventional method adopts serial computing, wherein blocks are predicted one by one. While parallel computing can be used to accelerate frame prediction, parallel dependence may be generated.

Thus, a memory arrangement method and system for AC/DC prediction in video compression applications based on parallel processing is desirable, achieving simultaneous prediction of multiple macroblocks at a time, wherein parallel computing is not restrained due to dependence.

### BRIEF SUMMARY OF THE INVENTION

Memory arrangement methods for AC/DC prediction in video compression applications based on parallel processing are provided. An exemplary embodiment of a memory arrangement method for AC/DC prediction in video compression applications based on parallel processing comprises the following. A frame of video stream data is retrieved from an off-chip memory. A first macroblock group of a first chunk group (defined in FIG. 5) of the frame is processed by retrieving top reference coefficients of the first macroblock of the frame from a prior buffer using plural parallel operation units. Left and top-left reference coefficients of the first macroblock are retrieved using an inter-lane permutation mechanism between operation lanes. An AC/DC prediction operation is performed according to the retrieved reference coefficients and it is determined whether the current macroblock group (defined in FIG. 5) which is being processed is the last macroblock group of the corresponding row chunk. The next macroblock group of the corresponding row chunk is continuously processed if the current macroblock group which is being processed is not the last macroblock group. It is determined whether the chunk group being processed is the last chunk group if the current macroblock group which is being processed is the last macroblock group. The described steps are repeated, if the chunk group being processed is not the last chunk group, until the AC/DC prediction operation for the frame is complete. The AC/DC prediction operation for the frame is complete if the chunk group being processed is the last chunk group.

Memory arrangement systems for AC/DC prediction in video compression applications based on parallel processing are provided. An exemplary embodiment of a memory arrangement system for AC/DC prediction in video compression applications based on parallel processing comprises an off-chip memory, an on-chip memory, and a data parallel unit. The off-chip memory retrieves a frame from video stream data. The on-chip memory further comprises plural parallel first operation units, retrieving the frame from the off-chip memory, wherein each macroblock of the frame comprises P luminance blocks and Q chrominance blocks, and P and Q are integral multiples of 4 and 2, respectively. The data parallel unit further comprises plural parallel second operation units and an inter-lane switch. The parallel second operation units retrieve the frame from the on-chip memory, start to process a first macroblock group of a first chunk group of the frame, and retrieve top reference coefficients of the first macroblock group of the frame using a prior buffer. The inter-lane switch retrieves left and top-left reference coefficients of the first macroblock using an inter-lane permutation mechanism between operation lanes. The data parallel unit performs an AC/DC prediction operation for the frame according to the retrieved reference coefficients and determines whether the current macroblock group which is being processed is the last macroblock group of the corresponding row chunk, continuously processes the next macroblock group of the corresponding row chunk if the current macroblock group which is being processed is not the last macroblock group, determines whether the chunk group being processed is the last chunk group if the current macroblock group which is being processed is the last macroblock group, repeats the described steps, if the chunk group being processed is not the last chunk group, until the AC/DC prediction operation for the frame is complete, and completes the AC/DC prediction operation for the frame if the chunk group being processed is the last chunk group.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of serial and parallel processing for top reference coefficients;

FIG. 2 is a schematic view of serial and parallel processing for left and top-left reference coefficients;

FIG. 3 is a schematic view of a memory arrangement system for AC/DC prediction in video compression applications based on parallel processing of the present invention;

FIG. 4 is a schematic view of data pre-arrangement of the present invention;

FIG. 5 is a schematic view of image block definitions of the present invention;

FIG. 6 is a schematic view of AC/DC prediction in video compression applications of the present invention;

FIG. 7 is a schematic view of reading reference coefficients of the blocks using a parallel computing operation of the present invention;

FIG. 8 is a schematic view of a prior buffer of the present invention;

FIGS. 9A and 9B are schematic views of reading macroblocks by the prior buffer of the present invention;

FIG. 10A is a schematic view of reference coefficients of left blocks of the present invention;

FIG. 10B is a schematic view of inter-lane permutation between operation lanes of the present invention;

FIG. 11 is a flowchart of retrieving left reference coefficients of each block of the present invention;

FIG. 12 is a schematic view of overlapping processing for loading data of chunk groups of a frame of the present invention;

FIG. 13 is a schematic view of overlapping processing for data restore of chunk groups of a frame of the present invention;

FIGS. 14-1 and 14-2 are schematic views of loading data for boundary expansion of a frame of the present invention;

FIGS. 15-1 and 15-2 are schematic views of data restore for boundary expansion of a frame of the present invention; and

FIG. 16 is a flowchart of a memory arrangement method for AC/DC prediction in video compression applications based on parallel processing of the present invention.

### DETAILED DESCRIPTION OF THE INVENTION

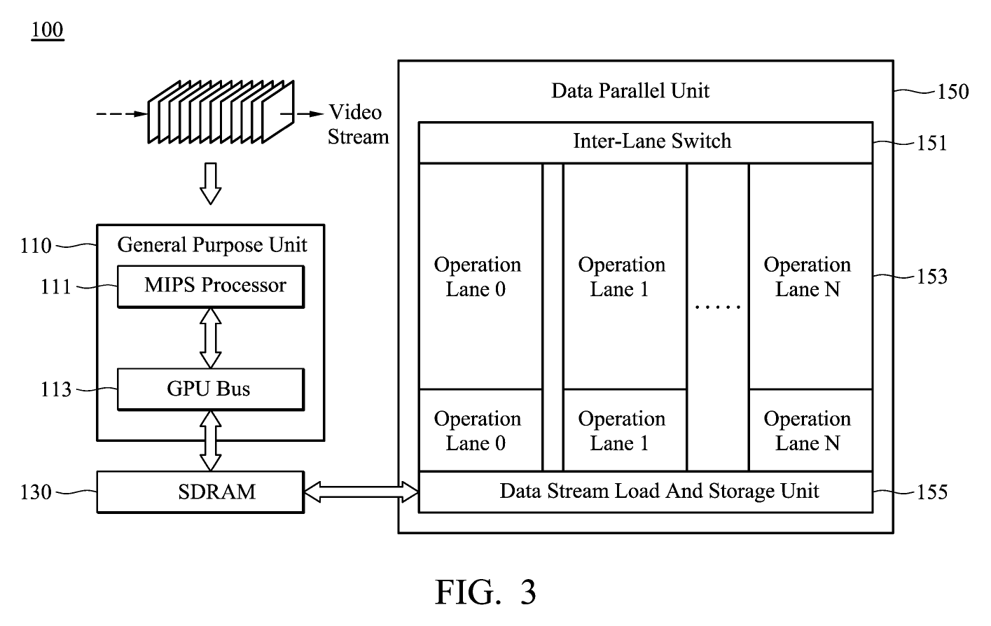

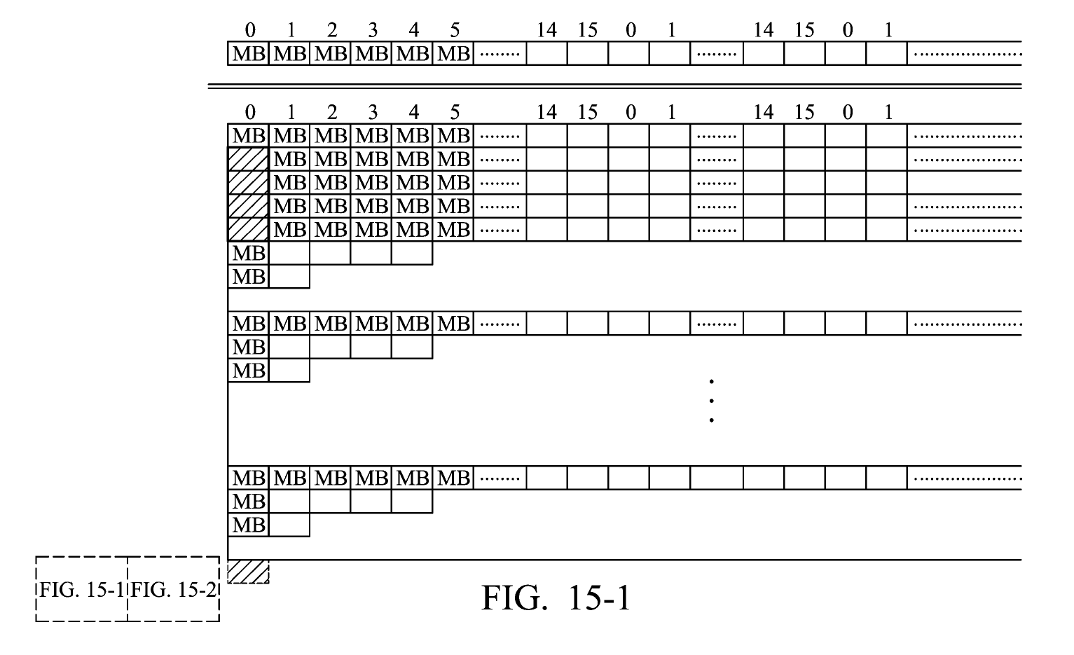

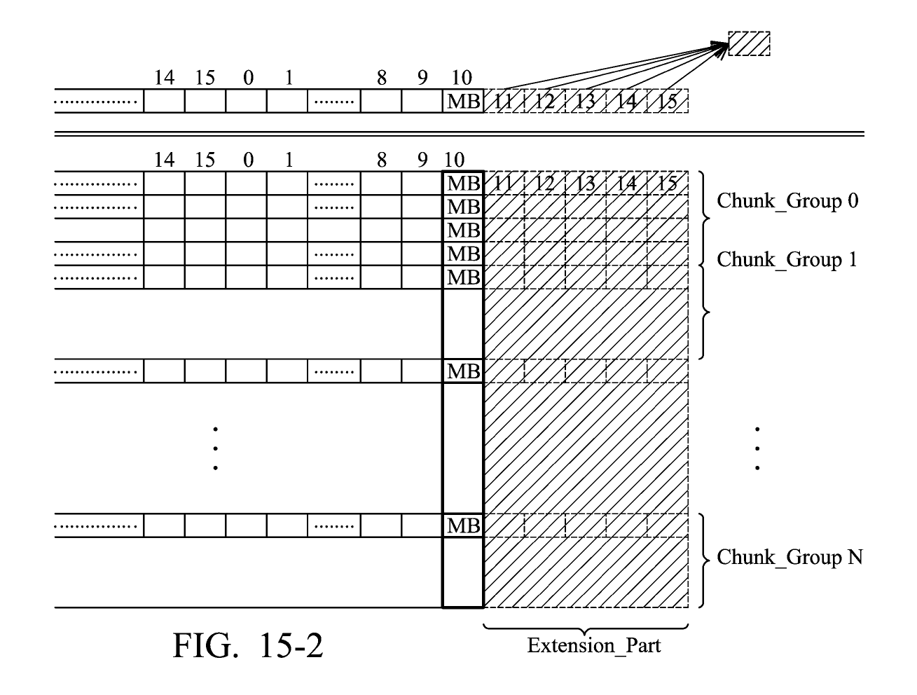

Several exemplary embodiments of the invention are described with reference to FIGS. 3 through 16, which generally relate to memory arrangement for AC/DC prediction in video compression applications based on parallel processing. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a memory arrangement method and system for AC/DC prediction in video compression applications based on parallel processing.

An embodiment of a memory arrangement method and system for AC/DC prediction in video compression applications based on parallel processing achieves optimum operating efficiency for data operation and reading based on parallel computing characteristics (Single Instruction Multiple Data (SIMD)) of an operation unit of the system. Additionally, the method transplants a VC-1 video compression system running in an operating system (the Windows operating system, for example) to a system platform using a digital signal processor (DSP) as an operation unit and implements a real-time VC-1 encoder according to parallel computing characteristics of a hardware core of the system platform.

FIG. 3 is a schematic view of a memory arrangement system for AC/DC prediction in video compression applications based on parallel processing of the present invention.

The memory arrangement system 100 comprises a general purpose unit 110, a synchronous dynamic random access memory (SDRAM) 130, and a data parallel unit 150. The general purpose unit 110 further comprises a processor 111 with millions of instruction per second (MIPS) and a general purpose unit (GPU) bus 113. The MIPS processor 111 is responsible for system tasks. The GPU bus 113 is responsible for communicating with the system input and output (I/O) of peripheral components and user interfaces of applications. The SDRAM 130 is an off-chip access unit.

The data parallel unit 150, responsible for parallel computing of mass data, further comprises an inter-lane switch 151, plural operation lanes 153, and a data stream load and storage unit 155. In this embodiment, the system 100 comprises 16 operation lanes (0˜N, N=15, comprising data parallel processing lanes 0˜15 and inter access unit lanes 0˜15) but is not to be limitative. Each operation lane can be served as an independent operation unit, i.e. a data parallel processing lane, each independent operation unit comprises its own inter access unit (or so-called lane register file (LRF)), and an operation instruction can be simultaneously implemented to 16 operation lanes. That is to say, a task is being performed each time, thus enhancing operating efficiency via mass data parallel operations.

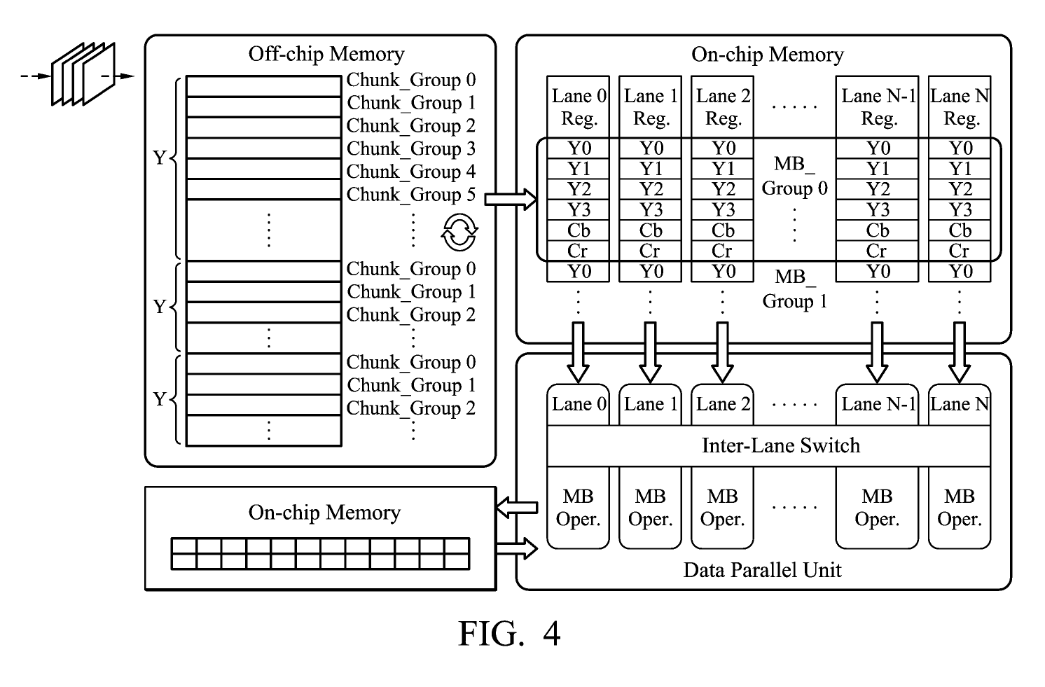

FIG. 4 is a schematic view of data pre-arrangement of the present invention.

As described, each operation lane comprises its own inter access unit (or named by temporary storage unit), which is regarded as an on-chip memory herein, and an inter-lane permutation mechanism is provided between the operation lanes. A data pre-arrangement process is described in the following. When video stream data of a frame is retrieved, raw data of the video stream data is pre-arranged in an off-chip memory (with frame based data access), where the raw data comprises plural chunk groups for signals Y, C_{b} and Cᵣ, and the chunk groups are sequentially loaded in an on-chip memory with chunk group based data access. Next, each operation lane starts the processing process and, when the whole data processing process is complete, processing results of the operation lanes are written back in the off-chip memory. The described operations are repeated to sequentially process raw data of the frame until the whole the whole frame is completely processed, temporarily storing top reference coefficients (including DC reference coefficients of a pixel and AC reference coefficients of 7 pixels) of each block.

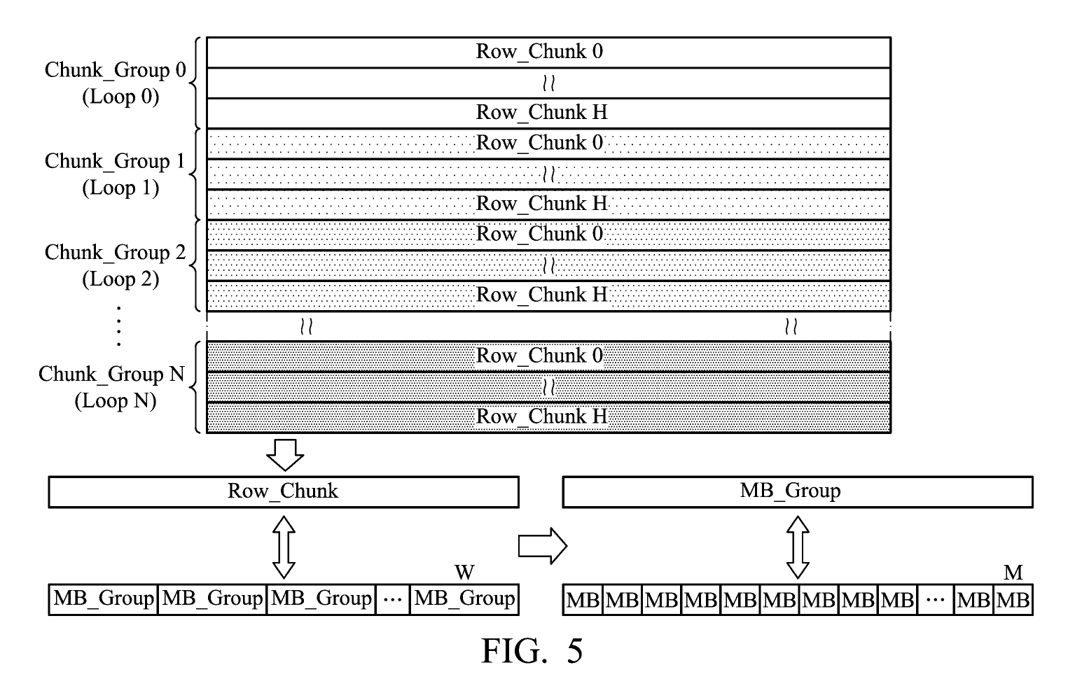

FIG. 5 is a schematic view of image block definitions of the present invention. Each frame is composed of N chunk groups, each chunk group is composed of H row chunks, and a row chunk comprises w macroblock groups. If a parallel structure provides M operation lanes, a macroblock group comprises M macroblocks, wherein each macroblock comprises P luminance blocks and Q chrominance blocks, and P and Q are integral multiples of 4 and 2, respectively. A basic unit for each operation lane, wherein arrangement and calculation is performed once, is a macroblock. Storage and arrangement sequence of macroblock groups of each row chunk is represented by arranging the chrominance blocks after the luminance blocks.

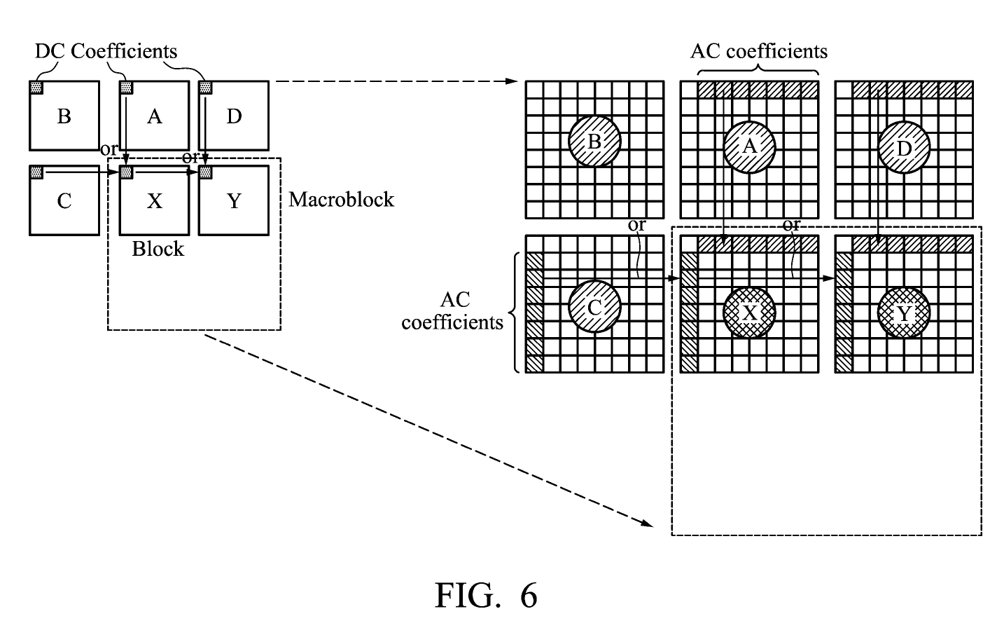

FIG. 6 is a schematic view of AC/DC prediction in video compression applications of the present invention. The AC/DC prediction in a digital video compression system predicts a block close to a currently processed block and calculates differences between the two blocks to reduce data amount. As shown in FIG. 6, if the currently processed block is X, the DC prediction value of X is retrieved according to DC reference coefficients of the top neighboring block A or the left neighboring block C, depending on the difference between the blocks A and B and between the blocks A and C. The AC prediction value is determined depending on where the DC prediction value is retrieved. If the DC prediction value is retrieved from the top neighboring block A, it is calculated according to the AC reference coefficients of 7 pixels of the first row of the top neighboring block A. Alternatively, if the DC prediction value is retrieved from the left neighboring block C, it is calculated according to the AC reference coefficients of 7 pixels of the first row of the left neighboring block C.

As described, each operation lane only reads a DC reference coefficient of a pixel of the top-left block of each block and AC reference coefficients of 7 pixels of the first row and the first column of each block (totally 15 pixels) from the individual temporary storage units to perform operations.

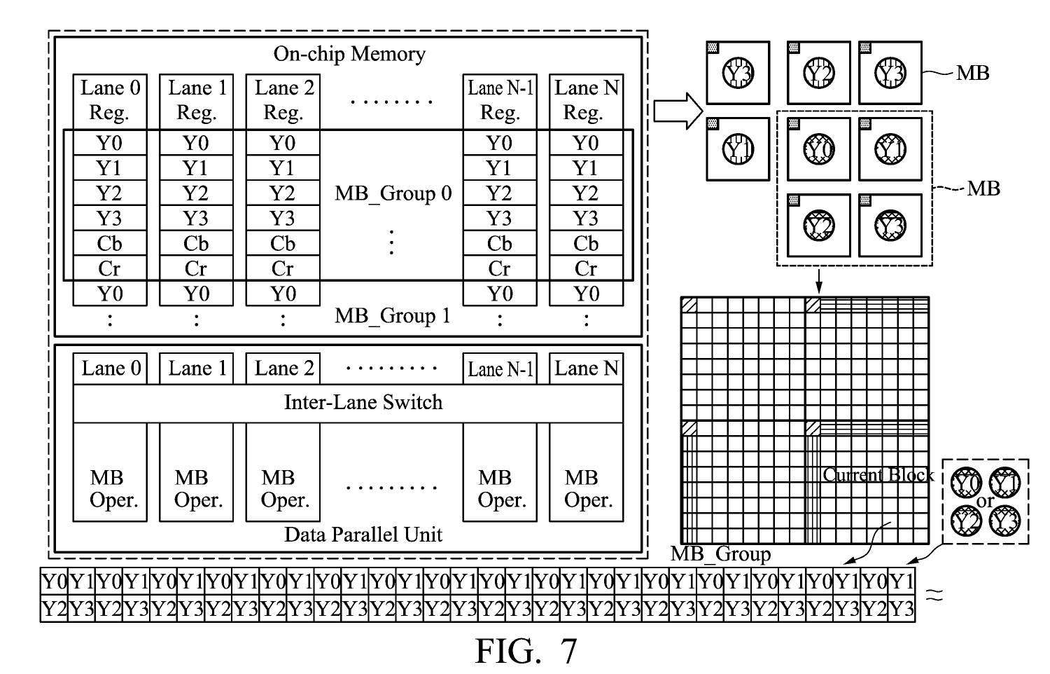

FIG. 7 is a schematic view of reading reference coefficients of the blocks using a parallel computing operation of the present invention.

Referring to FIG. 7, before AC/DC operations for each block are performed, either reference coefficients of 15 pixels for the current block or reference coefficients of 8 pixels (a DC reference coefficient of a pixel and AC reference coefficients of 7 pixels) of the first row of the top block, a DC reference coefficient of a pixel of the top-left block, and reference coefficients of 8 pixels (a DC reference coefficient of a pixel and AC reference coefficients of 7 pixels) of the first column of the top block must be retrieved, as described in the following.

As shown in FIG. 7, with respect to the Y3 block, top-left, top, and left reference coefficients (i.e. reference coefficients of the top-left, top, and left blocks) are respectively retrieved from the Y0, Y1, and Y2 blocks. With respect to the Y2 block, top reference coefficients can be retrieved from the Y0 block and top-left and left reference coefficients are respectively retrieved from the Y3 and Y1 blocks of the left neighboring macroblock. An inter-lane permutation mechanism between operation lanes is applied to allow greater efficiency for retrieving the left and top-left reference coefficients of each operation block. With respect to the Y1 block, left reference coefficients can be retrieved from the Y0 block and top-left and top reference coefficients are respectively retrieved from the Y2 and Y3 blocks of the top neighboring macroblock. Pre-storing reference coefficients of the previous row chunk using a prior buffer allows greater efficiency for retrieving the top reference coefficients of each operation block of the next row chunk.

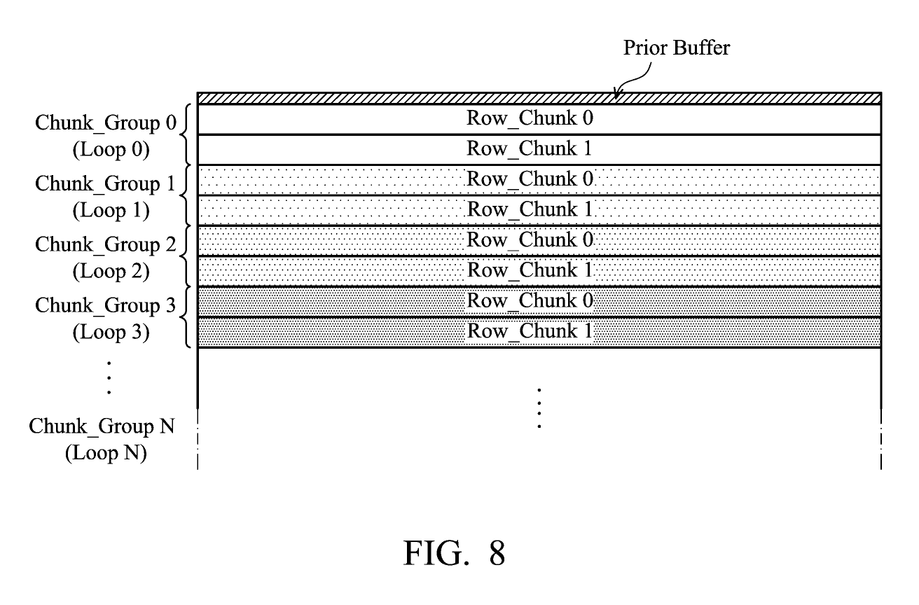

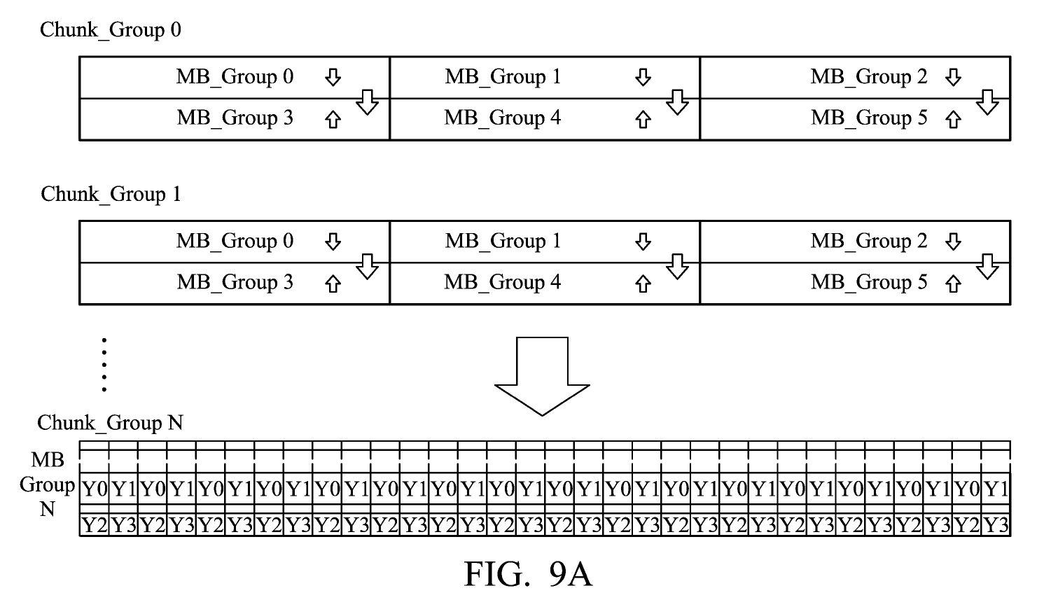

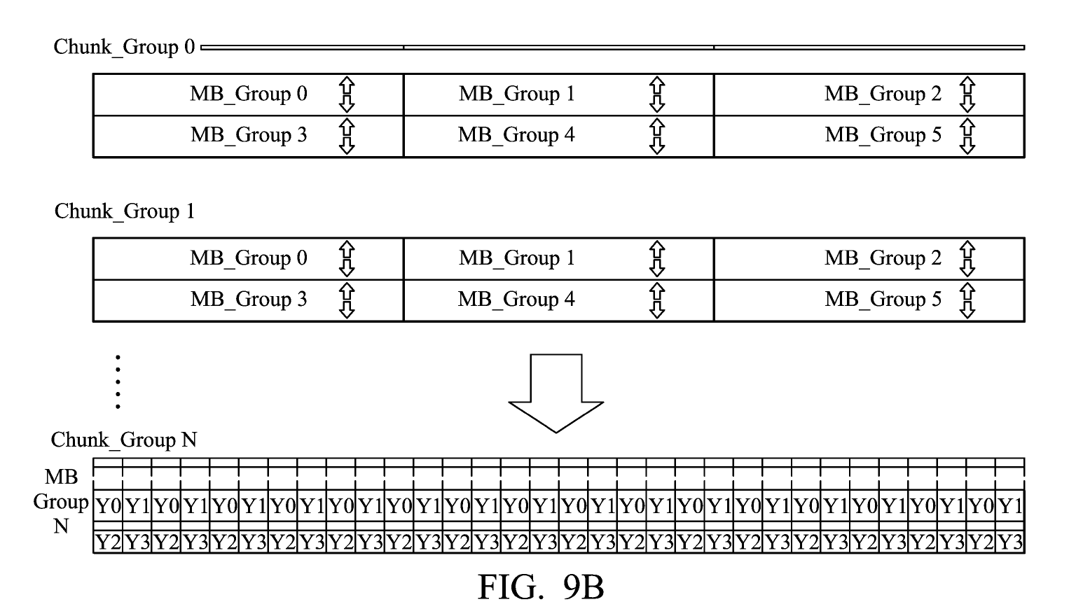

FIG. 8 is a schematic view of a prior buffer of the present invention. FIGS. 9A and 9B are schematic views of reading macroblocks by the prior buffer of the present invention.

Referring to FIG. 8, a frame is composed of N chunk groups, where each chunk group represents data amount for one loading in an on-chip memory and each chunk group is composed of 2 row chunks, where a row chunk is composed of 3 macroblock groups (not shown). Thus, each chunk group comprises 6 macroblock groups. Referring to FIG. 9A, each macroblock group is composed of 16 macroblocks. Before processing of the 0-th chunk group starts, default values are pre-stored in the prior buffer. When the processing starts, three macroblock groups (MB_Group0, MB_Group1, and MB_Group2) of the 0-th row chunk reads data in the prior buffer to be served as top reference coefficients of the Y0 and Y1 blocks of each macroblock groups. Next, macroblocks groups MB_Group3, MB_Group4, and MB_Group5 respectively reads reference coefficients of 8 pixels of the first row of the Y2 and Y3 blocks in the macroblock groups MB_Group0, MB_Group1, and MB_Group2 to be served as top reference coefficients of the Y0 and Y1 blocks of each macroblock groups. Meanwhile, reference coefficients of 8 pixels of the first row of the Y2 and Y3 blocks in the macroblock groups MB_Group3, MB_Group4, and MB_Group5 are written to the prior buffer to be served as top reference coefficients of the blocks of the first row chunk of the next chunk group. The described steps are repeated until all the chunk groups of the frame are completely processed.

As described, when a chunk group comprises multiple row chunks, data stored in the prior buffer is read only when the first row chunk of the first chunk group is processed, and top reference coefficients of the blocks of the on-chip memory are read when remaining row chunks are processed. With respect to writing data in the prior buffer, reference coefficients of 8 pixels of the first row of the Y2 and Y3 blocks of each macroblock group are written to the prior buffer, only when the last row chunk is processed, to be served as top reference coefficients of the blocks of the first row chunk of the next chunk group.

The described process results in irregularity for each chunk group retrieving top reference coefficients, as sometimes, the prior buffer is read and sometimes the on-chip memory is read. The irregularity results in behavioral branch issues which critically affects operating efficiency of parallel computing. Thus, to mitigate the issues, the process is adjusted so that each row chunk only reads the prior buffer, as shown in FIG. 9B.

During the start of processing each frame, default values are pre-stored in the prior buffer and each row chunk reads data in the prior buffer to be served as top reference coefficients of the Y0 and Y1 blocks. Meanwhile, reference coefficients of 8 pixels of the first row chunk of the Y2 and Y3 blocks of the row chunk being processed are written to the prior buffer to be served as top reference coefficients of the blocks of the next row chunk. The described process is repeated until processing for the whole frame is complete. Thus, because the described data process is more regular, behavioral branch issues are not generated. Additionally, only the prior buffer is read so the process is less complex.

The description mentioned above, explains how reference coefficients of 8 pixels of a neighboring block above a currently processed block within each macroblock are retrieved for parallel computing. Next, it will be explained how reference coefficients of 8 pixels of the first row of a left neighboring block of a currently processed block within each macroblock are retrieved.

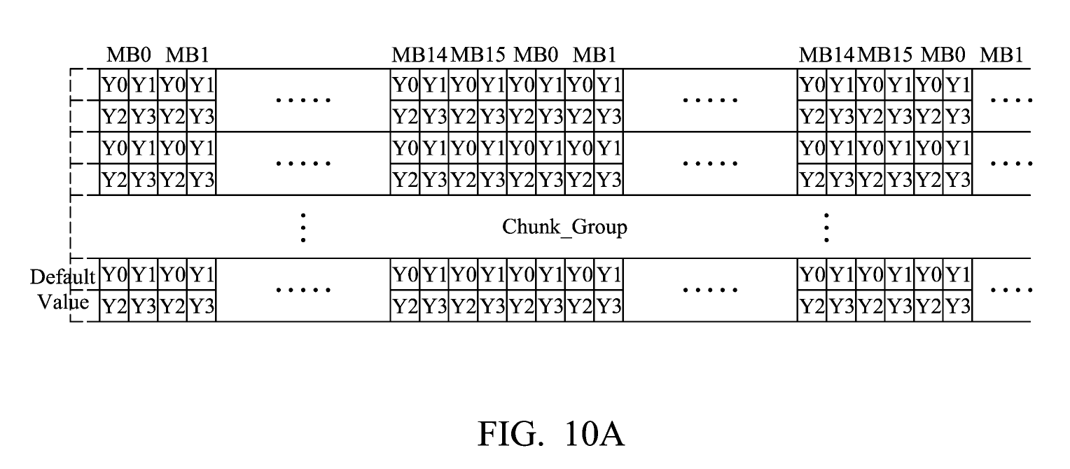

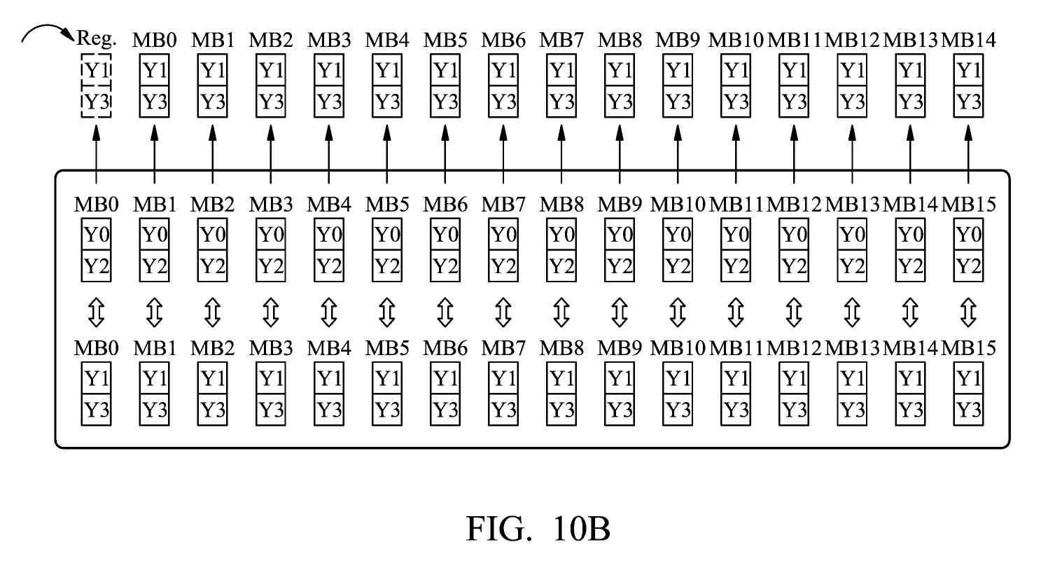

FIG. 10A is a schematic view of reference coefficients of left blocks of the present invention. FIG. 10B is a schematic view of inter-lane permutation between operation lanes of the present invention.

Referring to FIG. 10A, the left boundary of the frame contains no image data so a default value serves as boundary data. FIG. 10B shows inter-lane permutation between operation lanes corresponding to a macroblock. With respect to Y1 and Y3 blocks, because Y0 and Y2 blocks are within the same operation lane and are left neighboring reference blocks, left reference coefficients can be directly retrieved therefrom. However, with respect to Y0 and Y2 blocks, because their left neighboring blocks are Y1 and Y3 blocks of the previous operation lane, left reference coefficients can be retrieved by the inter-lane permutation between the operation lanes. In other words, the left neighboring reference blocks corresponding to the Y0 and Y2 blocks of the first macroblock of each macroblock group represents the Y1 and Y3 blocks of the last macroblock of the previous macroblock group.

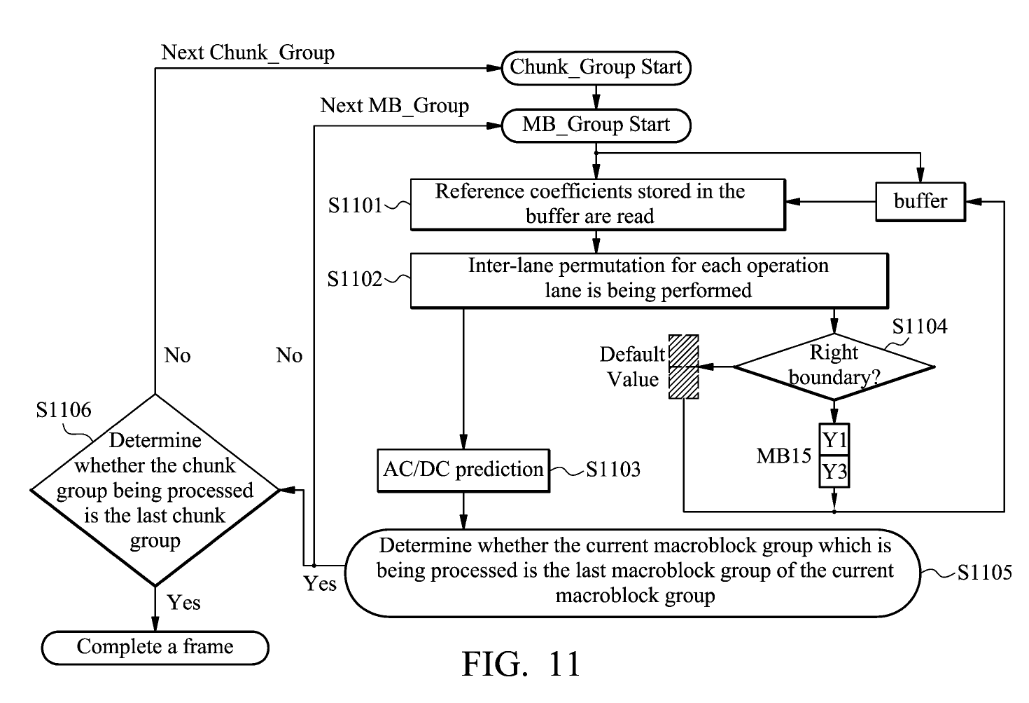

FIG. 11 is a flowchart of retrieving left reference coefficients of each block of the present invention.

Because a buffer pre-stores left reference coefficients of the Y0 and Y2 blocks of the first macroblock of each macroblock group, reference coefficients stored in the buffer are first read (step S1101) as inter-lane permutation for each operation lane is being performed (step S1102). When the inter-lane permutation and arrangement is complete, two operation processes are simultaneously performed, comprising AC/DC prediction (step S1103) and it is determined whether the current macroblock group which is being processed is the last macroblock group of the current macroblock group row chunk (step S1104 and S1105).

If the current macroblock group which is being processed is not the last macroblock group, a boundary flag is set to 0 and left reference coefficients of the last macroblock are stored in the buffer to be left reference coefficients of the Y0 and Y2 block of the first macroblock of the next macroblock group. If the current macroblock group which is being processed is the last macroblock group, the boundary flag is set to 1 and the default value is stored in the buffer, which indicate that the next operation cycle should start from the left most macroblock group of the next chunk group. Next, it is determined whether the chunk group being processed is the last chunk group (step S1106). The described steps are repeated if the chunk group being processed is not the last chunk group, until the AC/DC prediction operation for the frame is complete. Inside each macroblock, DC reference coefficients of the top-left neighboring block of the currently processed block can be retrieved by retrieving the top reverence coefficients of the currently processed block using the prior buffer by performing the inter-lane permutation between operation lanes. Thus, necessary reference coefficients are retrieved and each operation lane starts the AC/DC prediction.

Data stored in the buffer is determined depending on the boundary flag. When inter-lane permutation between operation lanes for the next macroblock group is being performed, a default value is loaded, when the boundary flag is 1, and reference coefficients of the first column of a block of the last operation lane of the previous macroblock group is loaded, when the boundary flag is 0, to be served as the left reference coefficients of a block of the first operation lane. Additionally, the boundary flag is set to 1 only before the last macroblock group of each row chunk and each frame are processed and to 0 at other operation conditions.

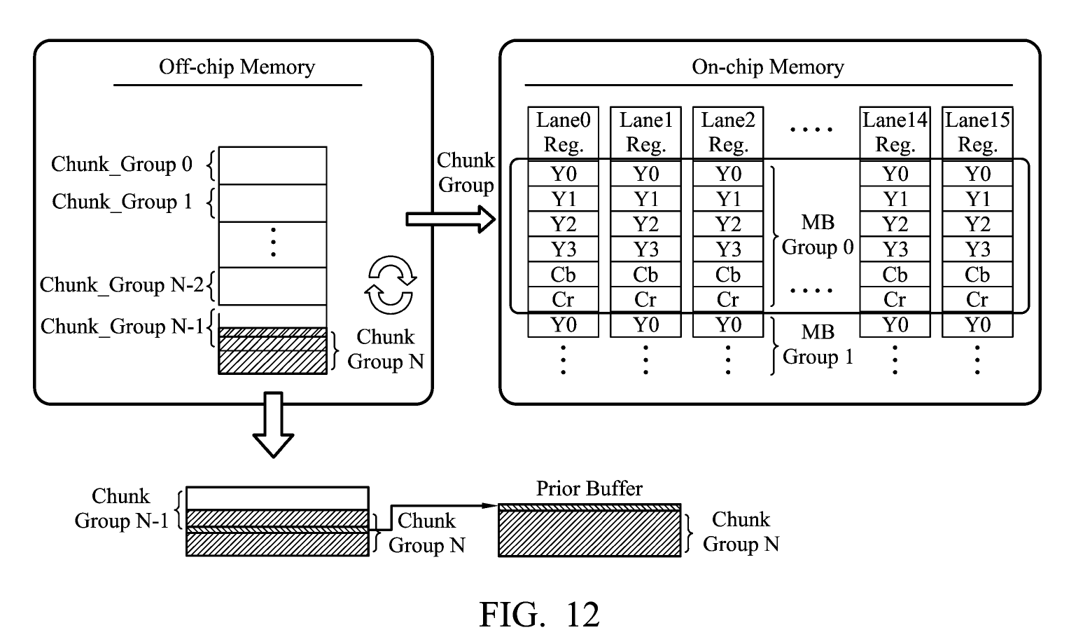

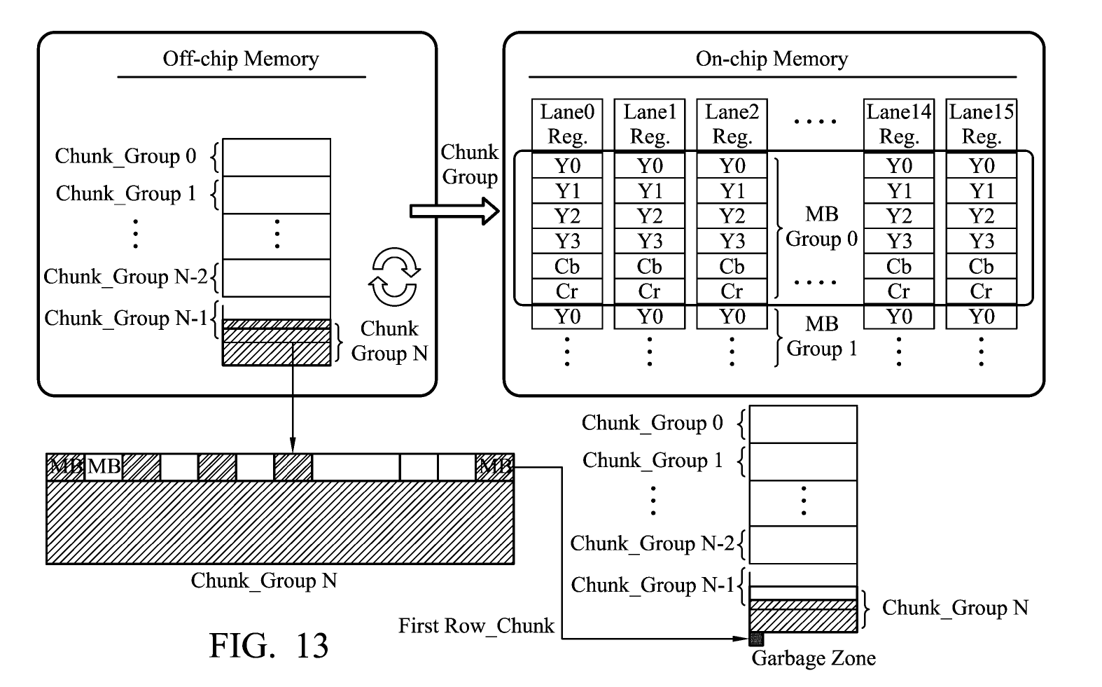

With respect to overlapping processing for loading data of chunk groups of a frame, frame resolution is not an integral multiple of on-chip memories and regularity for loading parallel data in the on-chip memory should be considered, so that a portion of frame data is overlapped to complement the last chunk group to enhance loading data efficiency, as shown in FIG. 12. When AC/DC prediction of each chunk group is complete, prediction results are restored to the off-chip memory. When AC/DC prediction of the reciprocal two chunk group is complete, and the stored data in the prior buffer is not the top reference coefficients of a block corresponding to the last chunk group, correctness of the final prediction result is affected, as shown in FIG. 12. Additionally, to keep regularity of restored data of each chunk group to the off-chip memory, in addition to the first row chunk of the last chunk group (i.e. a garbage zone), prediction results of remaining row chunks are written to corresponding memory blocks, as shown in FIG. 13.

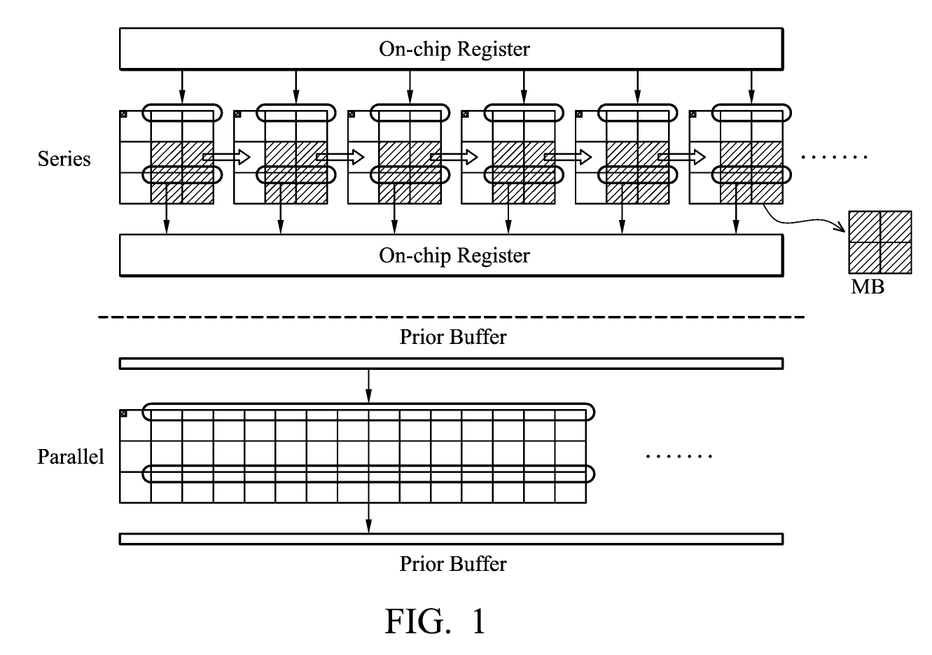

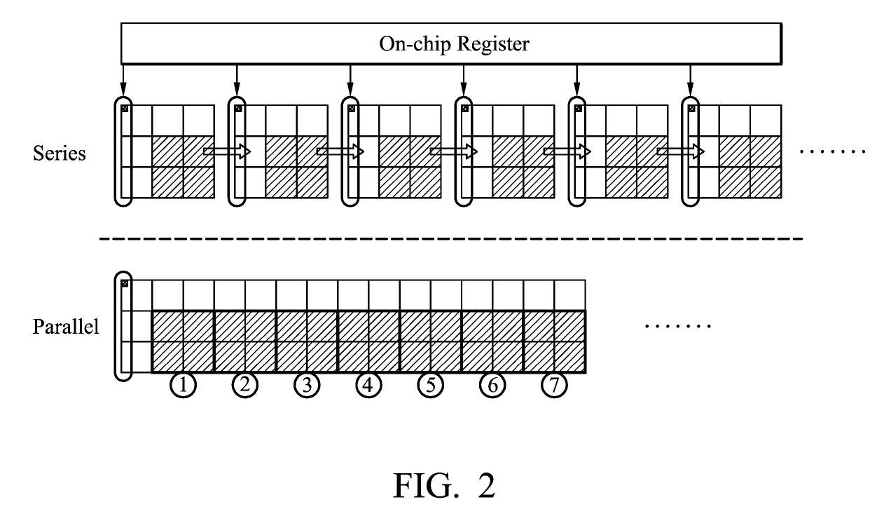

With respect to boundary expansion of a frame for data loaded in the on-chip memory, since the real frame width is not an integral multiple of on-chip memories and regularity for loading parallel data in the on-chip memory should be considered, an extension part of the frame is copied to expand the frame to an integral multiple of the on-chip memories, enhancing loading data efficiency, as shown in FIGS. 14-1 and 14-2. Additionally, prediction results of each chunk group should be restored to an initial memory block of the next chunk group to reach correctness of the frame prediction, as shown in FIGS. 15-1 and 15-2.

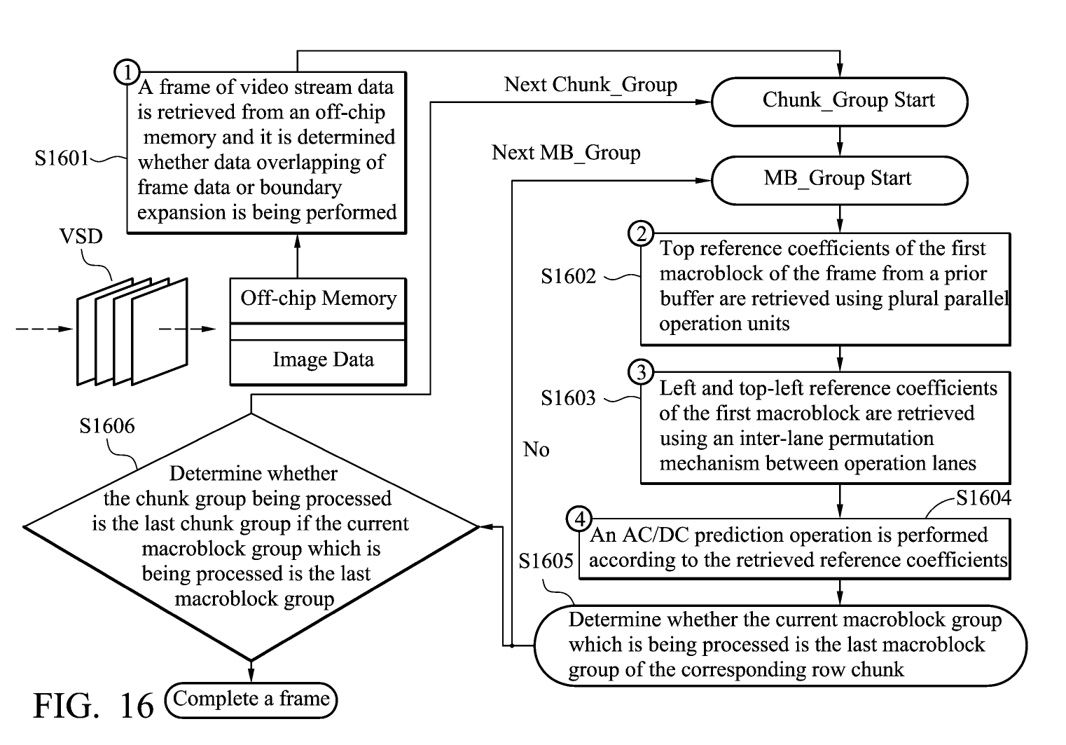

FIG. 16 is a flowchart of a memory arrangement method for AC/DC prediction in video compression applications based on parallel processing of the present invention.

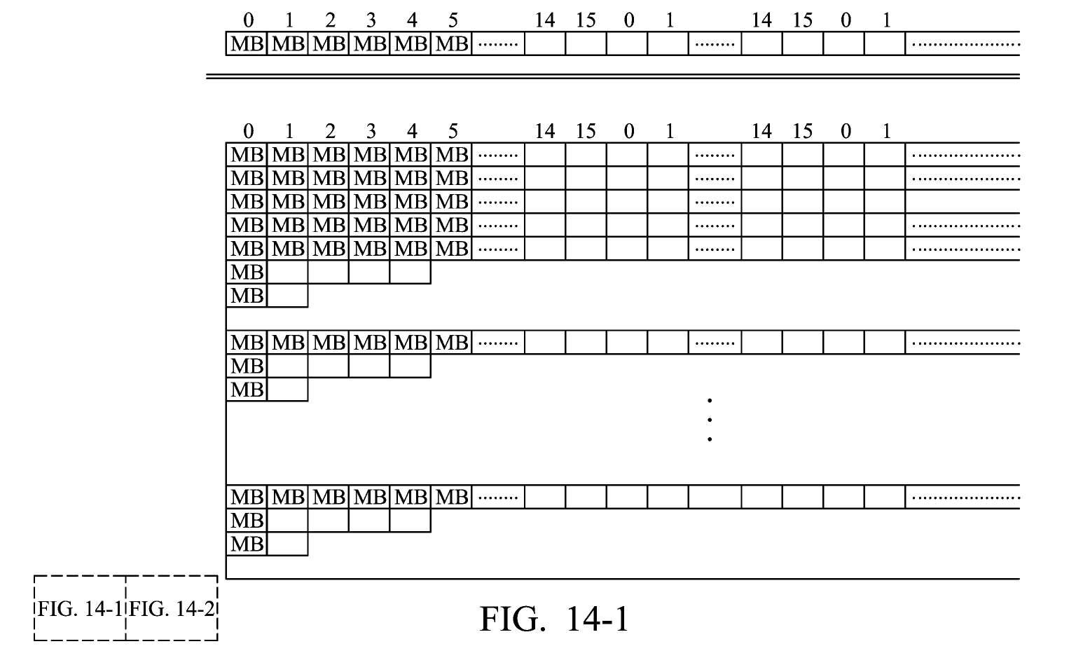

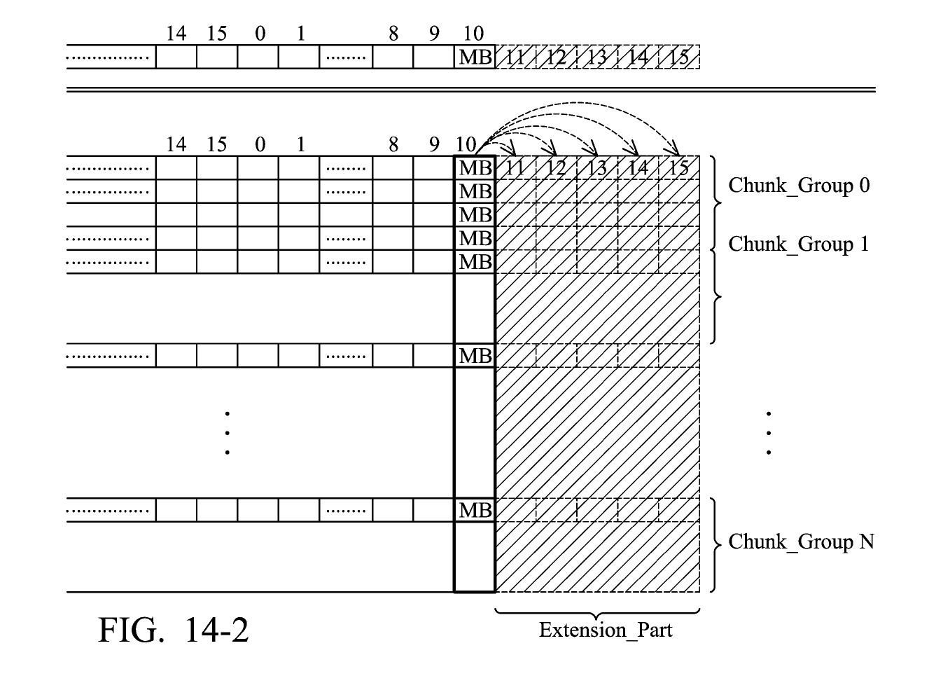

A frame of video stream data is retrieved from an off-chip memory and it is determined whether data overlapping of frame data or boundary expansion is being performed (step S1601). If the data overlapping is being performed, the process shown in FIGS. 12 and 13 is applied for implementation. If data boundary expansion is being performed, the process shown in FIGS. 14-1˜15-2 is applied for implementation. Next, the first macroblock group of the first chunk group is processed, wherein top reference coefficients of the first macroblock of the frame from a prior buffer are retrieved using plural parallel operation units (step S1602). Left and top-left reference coefficients of the first macroblock are retrieved using an inter-lane permutation mechanism between operation lanes (step S1603). An AC/DC prediction operation is performed according to the retrieved reference coefficients (step S1604) and it is then determined whether the current macroblock group which is being processed is the last macroblock group of the corresponding row chunk (step S1605). The next macroblock group of the corresponding row chunk is continuously processed if the current macroblock group which is being processed is not the last macroblock group. It is determined whether the chunk group being processed is the last chunk group if the current macroblock group which is being processed is the last macroblock group (step S1606). The described steps are repeated, if the chunk group being processed is not the last chunk group, until the AC/DC prediction operation for the frame is complete. The AC/DC prediction operation for the frame is complete if the chunk group being processed is the last chunk group.

Note that implementation processes of the figures herein are not totally described but processing means thereof are known by persons in the art, so that the invention can be implemented accordingly without detailed disclosed. The invention is implemented using parallel computing to improve operating efficiency for AC/DC prediction of video compression applications.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A memory arrangement method for AC/DC prediction in video compression applications based on parallel processing, comprising:
retrieving a frame of video stream data from an off-chip memory;
processing a first macroblock group of a first chunk group of the frame, wherein top reference coefficients of the first macroblock of the frame are retrieved from a prior buffer using plural parallel operation units;
retrieving left and top-left reference coefficients of the first macroblock using an inter-lane permutation mechanism between operation lanes;
performing an AC/DC prediction operation for the frame according to the retrieved reference coefficients and determining whether the current macroblock group which is being processed is the last macroblock group of the corresponding row chunk;
continuing to process the next macroblock group of the corresponding row chunk if the current macroblock group which is being processed is not the last macroblock group;
determining whether the chunk group being processed is the last chunk group if the current macroblock group which is being processed is the last macroblock group;
repeating the described steps, if the chunk group being processed is not the last chunk group, until the AC/DC prediction operation for the frame is completed; and
completing the AC/DC prediction operation for the frame if the chunk group being processed is the last chunk group.

2. The memory arrangement method for AC/DC prediction in video compression applications based on parallel processing as claimed in claim 1, further comprising:
determining whether data overlapping of frame data or boundary expansion is being performed when the frame is retrieved from the video stream data;
enhancing the last chunk group by an overlapping portion of frame data, if data overlapping is being performed; and
making the frame an integral multiple of the operation units, if boundary expansion is being performed

3. The memory arrangement method for AC/DC prediction in video compression applications based on parallel processing as claimed in claim 2, wherein, during data overlapping, prediction results are written to corresponding memory blocks in addition to the first row chunk of the last chunk group.

4. The memory arrangement method for AC/DC prediction in video compression applications based on parallel processing as claimed in claim 2, wherein, during boundary expansion, the last prediction results of the boundary expansion blocks of each chunk group are restored to an initial memory block of the next chunk group.

5. The memory arrangement method for AC/DC prediction in video compression applications based on parallel processing as claimed in claim 1, wherein the frame is composed of N chunk groups, each chunk group is composed of H row chunks, and a row chunk comprises w macroblock groups.

6. The memory arrangement method for AC/DC prediction in video compression applications based on parallel processing as claimed in claim 1, wherein, a macroblock group comprises M macroblocks, and if the parallel operation unit comprises M operation lanes, each macroblock comprises P luminance blocks and Q chrominance blocks, P and Q are integral multiples of 4 and 2, respectively and a basic unit for an operation lane, wherein arrangement and calculation is performed once, is a macroblock.

7. The memory arrangement method for AC/DC prediction in video compression applications based on parallel processing as claimed in claim 6, wherein storage and arrangement sequence of macroblock groups of each row chunk is represented by arranging the chrominance blocks after the luminance blocks.

8. The memory arrangement method for AC/DC prediction in video compression applications based on parallel processing as claimed in claim 1, wherein coefficient information of the first row of each block of each row chunk of the frame is temporarily stored to be the top reference coefficients of the blocks of the next chunk group.

9. The memory arrangement method for AC/DC prediction in video compression applications based on parallel processing as claimed in claim 1, wherein, before a first row chunk of the first chunk group of the frame is calculated, a default value is loaded from a prior buffer or, after the AC/DC prediction operation is completed, top reference coefficients of the blocks required for the next row chunk are loaded in the prior buffer.

10. The memory arrangement method for AC/DC prediction in video compression applications based on parallel processing as claimed in claim 1, wherein the inter-lane permutation mechanism between the operation lanes exchanges left and top-left reference coefficients of macroblocks required for each operation lane.

11. The memory arrangement method for AC/DC prediction in video compression applications based on parallel processing as claimed in claim 1, wherein a left reference coefficient is temporarily stored using a buffer and the stored coefficient is determined according to a boundary flag, a default value is loaded in, when the boundary flag is 1 and the first column coefficient information of the blocks of the last operation lane of the previous macroblock group is loaded in, when the boundary flag is 0, to be left reference coefficients of the blocks of the first operation lane, and the boundary flag is set as 1, before the last macroblock groups of each row chunk and each frame are calculated, and 0 at other operation conditions.

12. The memory arrangement method for AC/DC prediction in video compression applications based on parallel processing as claimed in claim 1, wherein prediction results are restored to an off-chip memory when the AC/DC prediction operation for each chunk group is complete.

13. A memory arrangement system for AC/DC prediction in video compression applications based on parallel processing, comprising:
an off-chip memory, retrieving a frame from video stream data;
an on-chip memory, further comprising plural parallel first operation units, retrieving the frame from the off-chip memory, wherein each macroblock of the frame comprises P luminance blocks and Q chrominance blocks, where P and Q are integral multiples of 4 and 2 respectively; and
a data parallel unit, further comprising:
plural parallel second operation units, retrieving the frame from the on-chip memory, starting to process a first macroblock group of a first chunk group of the frame, and retrieving top reference coefficients of the first macroblock group of the frame using a prior buffer; and
an inter-lane switch, retrieving left and top-left reference coefficients of the first macroblock using an inter-lane permutation mechanism between operation lanes,
wherein the data parallel unit performs an AC/DC prediction operation for the frame according to the retrieved reference coefficients and determines whether the current macroblock group which is being processed is the last macroblock group of the corresponding row chunk, continuously processes the next macroblock group of the corresponding row chunk if the current macroblock group which is being processed is not the last macroblock group, determines whether the chunk group being processed is the last chunk group if the current macroblock group which is being processed is the last macroblock group, repeats the described steps, if the chunk group being processed is not the last chunk group, until the AC/DC prediction operation for the frame is complete, and completes the AC/DC prediction operation for the frame if the chunk group being processed is the last chunk group.

14. The memory arrangement system for AC/DC prediction in video compression applications based on parallel processing as claimed in claim 13, wherein the data parallel unit determines whether data overlapping of frame data or boundary expansion is being performed when the frame is retrieved from the video stream data, complements the last chunk group by an overlapping portion of frame data, if data overlapping is being performed, and makes the frame as an integral multiple of the operation units, if boundary expansion is being performed

15. The memory arrangement system for AC/DC prediction in video compression applications based on parallel processing as claimed in claim 14, wherein, during data overlapping, the data parallel unit writes prediction results in corresponding memory blocks in addition to the first row chunk of the last chunk group.

16. The memory arrangement system for AC/DC prediction in video compression applications based on parallel processing as claimed in claim 14, wherein, during boundary expansion, the data parallel unit restores the last prediction results of the boundary expansion blocks of each chunk group in an initial memory block of the next chunk group.

17. The memory arrangement system for AC/DC prediction in video compression applications based on parallel processing as claimed in claim 13, wherein the frame is composed of N chunk groups, each chunk group is composed of H row chunks, and a row chunk comprises w macroblock groups.

18. The memory arrangement system for AC/DC prediction in video compression applications based on parallel processing as claimed in claim 13, wherein, a macroblock group comprises M macroblocks if the parallel operation unit comprises M operation lanes, and each macroblock comprises P luminance blocks and Q chrominance blocks, P and Q are integral multiples of 4 and 2, respectively and a basic unit for an operation lane, wherein arrangement and calculation is performed once, is a macroblock.

19. The memory arrangement system for AC/DC prediction in video compression applications based on parallel processing as claimed in claim 18, wherein storage and arrangement sequence of macroblock groups of each row chunk is represented by arranging the chrominance blocks after the luminance blocks.

20. The memory arrangement system for AC/DC prediction in video compression applications based on parallel processing as claimed in claim 13, wherein the data parallel unit temporarily stores coefficient information of the first row of each block of each row chunk of the frame to be the top reference coefficients of the blocks of the next chunk group.

21. The memory arrangement system for AC/DC prediction in video compression applications based on parallel processing as claimed in claim 13, wherein the data parallel unit loads a default value in from a prior buffer, before a first row chunk of the first chunk group of the frame is calculated, or, loads top reference coefficients of the blocks required for the next row chunk in the prior buffer, after the AC/DC prediction operation is complete.

22. The memory arrangement system for AC/DC prediction in video compression applications based on parallel processing as claimed in claim 13, wherein the inter-lane permutation mechanism between the operation lanes exchanges left and top-left reference coefficients of the blocks required for each operation lane.

23. The memory arrangement method for AC/DC prediction in video compression applications based on parallel processing as claimed in claim 13, wherein the data parallel unit temporarily stores a left reference coefficient using a buffer and the stored coefficient is determined according to a boundary flag, a default value is loaded in, when the boundary flag is 1, and the first column coefficient information of the blocks of the last operation lane of the previous macroblock group is loaded in, when the boundary flag is 0, to be left reference coefficients of the blocks of the first operation lane, and the boundary flag is set as 1, before the last macroblock groups of each row chunk and each frame are calculated, and 0 at other operation conditions.

24. The memory arrangement method for AC/DC prediction in video compression applications based on parallel processing as claimed in claim 13, wherein the data parallel unit restores prediction results in an off-chip memory when the AC/DC prediction operation for each chunk group is complete.
